(19) United States
(12) Patent Application Publication
(10) Pub. No.: US 2014/0283999 A1
(43) Pub. Date: Sep. 25, 2014

(54) FILM RELEASING DEVICE AND FILM RELEASING METHOD

(71) Applicant: FUJI XEROX CO., LTD., Tokyo (JP)

(72) Inventor: Toshimasa SAKAE, Kanagawa (JP)

(73) Assignee: FUJI XEROX CO., LTD., Tokyo (JP)

(21) Appl. No.: 13/973,546

(22) Filed: Aug. 22, 2013

(30) Foreign Application Priority Data
Mar. 21, 2013 (JP) 2013-057464

(51) Int. Cl. B32B 43/00

(52) U.S. Cl. CPC B32B 43/006
USPC 156/707; 156/758

(57) ABSTRACT

A film releasing device includes at least one transport member configured to transport a stack of a substrate and a film and to discharge the stack, a negative-pressure-generating unit provided on a discharge side of the transport member and configured to attract the film with a negative pressure generated on a surface of the film, and a communicating portion communicating with atmosphere and provided in a region of the film that is on a side facing the substrate, the region overlapping a part of a negative-pressure-generated area of the film. The film is released from the substrate in such a manner as to be guided in a direction that is different from a direction of discharge while the film is attracted to the negative-pressure-generating unit.

### CROSS-REFERENCE TO RELATED APPLICATIONS

This application is based on and claims priority under 35 USC 119 from Japanese Patent Application No. 2013-057464 filed Mar. 21, 2013.

### BACKGROUND

### Technical Field

The present invention relates to a film releasing device and a film releasing method.

### SUMMARY

According to an aspect of the invention, there is provided a film releasing device that includes at least one transport member configured to transport a stack of a substrate and a film and to discharge the stack, a negative-pressure-generating unit provided on a discharge side of the transport member and configured to attract the film with a negative pressure generated on a surface of the film, and a communicating portion communicating with atmosphere and provided in a region of the film that is on a side facing the substrate, the region overlapping a part of a negative-pressure-generated area of the film. The film is released from the substrate in such a manner as to be guided in a direction that is different from a direction of discharge while the film is attracted to the negative-pressure-generating unit.

### BRIEF DESCRIPTION OF THE DRAWINGS

An exemplary embodiment of the present invention will be described in detail based on the following figures, wherein:

FIG. 1 is a schematic sectional view illustrating an exemplary outline configuration of a stack making apparatus to which a film releasing device according to the exemplary embodiment is applied;

FIG. 2 is a vertical sectional view illustrating a configuration of an image transferring device;

FIG. 3 is a vertical sectional view illustrating a configuration of the film releasing device;

FIG. 4A is a perspective view of one of a pair of suction cup units seen from a side from which a card substrate is fed thereto;

FIG. 4B is a perspective view of the suction cup unit seen from a side from which the card substrate is discharged;

FIG. 5 is a perspective view illustrating an internal configuration of one of a pair of film-discharging-roller units seen from the side from which the card substrate is discharged;

FIG. 6 is a sectional view illustrating a configuration of a stack obtained through lamination performed by the image transferring device;

FIGS. 7A to 7E are schematic diagrams illustrating steps of a film releasing operation performed by the film releasing device;

FIG. 8A is a schematic diagram illustrating a state where a negative pressure is generated between an attracted region of a front-side film and a card substrate in a related art;

FIG. 8B is a schematic diagram illustrating a state where suction is applied to a front-side film in Example 1; and

FIG. 8C is a schematic diagram illustrating a state where suction is applied to the front-side film in Example 2.

### DETAILED DESCRIPTION

An exemplary embodiment and examples of the present invention will now be described in detail with reference to the accompanying drawings. The present invention is not limited to the following exemplary embodiment and examples.

Note that the drawings to be referred to below are only schematic, and elements illustrated therein are not scaled to actual sizes. For the convenience of understanding, irrelevant elements are not illustrated.

### (1) Overall Configuration and Operation of Stack Making Apparatus

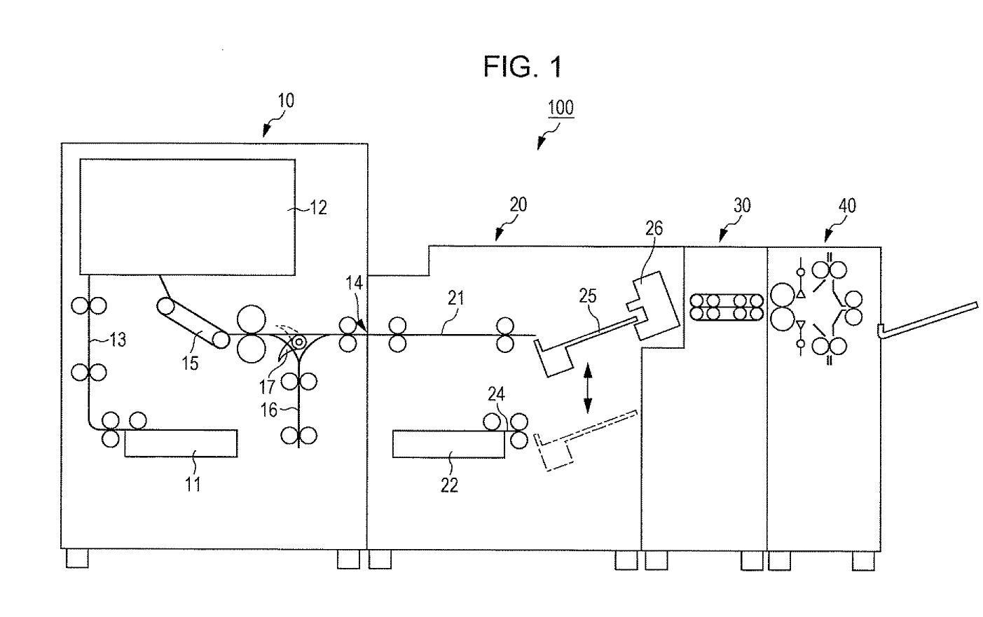

FIG. 1 is a schematic sectional view illustrating an exemplary outline configuration of a stack (plastic sheet) making apparatus 100 to which a film releasing device 40 according to the exemplary embodiment is applied.

The stack making apparatus 100 includes an image forming device (including a film storing section and an image forming section) 10, a gathering device 20, an image transferring device (including a laminating section) 30, and the film releasing device 40.

### (1.1) Image Forming Device

The image forming device 10 includes, for example, a film tray 11, an image forming section 12, a transport path 13 along which a transfer film as an exemplary first medium is transported from the film tray 11 to the image forming section 12, and a transport path 15 along which the transfer film that has undergone image formation is transported from the image forming section 12 to a discharge port 14. Illustration and description of other elements are omitted.

The image forming section 12 includes known electrophotographic, color image forming devices (not illustrated). Specifically, the image forming section 12 includes image forming units configured to form toner images in respective colors of black (K), cyan (C), magenta (M), and yellow (Y) on a medium; exposure units configured to expose the surfaces of photoconductor drums, which are included in the respective image forming units, to light and thus form electrostatic latent images on the surfaces of the photoconductor drums; developing units configured to develop the electrostatic latent images having been formed on the surfaces of the photoconductor drums into toner images with toners having the respective colors; transfer units configured to transfer the toner images having been formed on the surfaces of the photoconductor drums to a medium; a fixing unit configured to fix the toner images having been transferred to the medium by applying heat and pressure to the toner images; and so forth.

The transport paths 13 and 15 include plural pairs of rollers, including pairs of driving rollers, and plural guides (not illustrated). The transport path 15 further includes a reversal path 16 configured to turn the side of the transfer film that is being transported by 180°. A gate 17 configured to change the direction of guiding the transfer film is provided near a point where the transport path 15 and the reversal path 16 merge. When the transfer film is transported into the reversal path 16 and is returned to the transport path 15, the side of the transfer film that is being transported is turned by 180°, that is, the transfer film is turned upside down. Then, the transfer film is further transported.

### (1.2) Gathering Device

The gathering device 20 includes a card tray 22, a gathering tray (positioning unit) 25, a transport path 24 along which a card substrate 1 as an exemplary second medium is supplied from the card tray 22 to the gathering tray 25, and a transport path 21 along which the transfer film having been discharged from the discharge port 14 of the image forming device 10 is supplied to the gathering tray 25.

A discharge part of the transport path 24 along which the card substrate 1 is supplied to the gathering tray 25 and a discharge part of the transport path 21 along which the transfer film is supplied to the gathering tray 25 are aligned in the vertical direction.

The transport path 21 may include, for example, a smooth plate-like member and transport rollers configured to transport the transfer film along the surface of the plate-like member, or a belt-type rotating transport member. Such transport rollers or a belt rotates at a timing of discharge of the transfer film from the image forming device 10, whereby the transfer film is transported to the gathering tray 25.

The card tray 22 is provided with a pickup roller or a feed roller that is substantially the same as that included in a typical sheet feeding device. The roller such as the feed roller rotates immediately after the gathering tray 25 is moved to the discharge part of the card tray 22, and feeds a card substrate 1 to the gathering tray 25.

The gathering tray 25 is movable up and down between the discharge part of the transport path 24 and the discharge part of the transport path 21 so that the card substrate 1 and the transfer film are supplied to the gathering tray 25 from the respective discharge parts. The gathering tray 25 has a positioning member (not illustrated) with respect to which an end of the card substrate 1 and ends of a front-side film 3 and a back-side film 5 as transfer films that have been stacked on the card substrate 1 are aligned.

The gathering tray 25 is provided with a temporal tacking unit 26 configured to temporarily tack a stack of the two transfer films and the card substrate 1 that is interposed therebetween. The temporal tacking unit 26 includes, for example, a pair of projecting members that are made of metal so as to be heated by a heater or the like. One end of the stack is held between the pair of projecting members that have been heated, whereby the end of the stack is heat-sealed and is thus temporarily tacked.

If the temporal tacking unit 26 is provided in a path along which the stack is transported from the gathering tray 25 to the image transferring device 30, the temporal tacking unit 26 is provided in such a manner as to face the end of the gathering tray 25 only at the time of temporal tacking and to be retracted from the path in the other situations.

### (1.3) Image Transferring Device

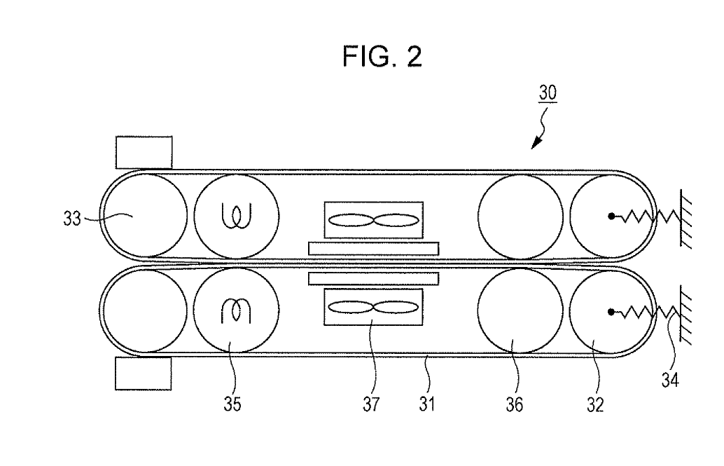

FIG. 2 is a vertical sectional view illustrating an exemplary configuration of the image transferring device 30. The image transferring device 30 includes a pair of belts 31, a pair of tension rollers 32, and a pair of inlet rollers 33. Each of the belts 31 is stretched between a corresponding one of the tension rollers 32 and a corresponding one of the inlet rollers 33 and is provided with a tension spring 34 so that the belt 31 is not distorted.

A pair of heating-and-pressing rollers 35 and a pair of cooling rollers 36 are provided on the inner side of the belts 31 and between the pair of tension rollers 32 and the pair of inlet rollers 33 such that the pair of heating-and-pressing rollers 35 are pressed against each other and the pair of cooling rollers 36 are pressed against each other with the belts 31 interposed therebetween. The pair of tension rollers 32 are not pressed against each other and do not form a nip therebetween. Likewise, the pair of inlet rollers 33 are not pressed against each other and do not form a nip therebetween. That is, gaps are provided between the pair of belts 31 where the tension rollers 32 and the inlet rollers 33 are provided. Hence, even if the belts 31 meander during their continuous rotation, the belts 31 are set back to respective predetermined positions while being rotated.

The stack is heat-sealed with heat and pressure applied by the heating-and-pressing rollers 35 provided behind the respective inlet rollers 33. Cooling fans 37 are each provided between a corresponding one of the heating-and-pressing rollers 35 and a corresponding one of the cooling rollers 36 so as to cool the stack that is at a glass transition temperature (TG) or above after passing through the nip between the heating-and-pressing rollers 35 to a temperature below TG. Hence, the stack passes through the nip between the cooling rollers 36 while retaining its flatness, is cooled to a temperature below the glass transition temperature, and is discharged from the side of the image transferring device 30 on which the tension rollers 32 are provided.

### (1.4) Film Releasing Device

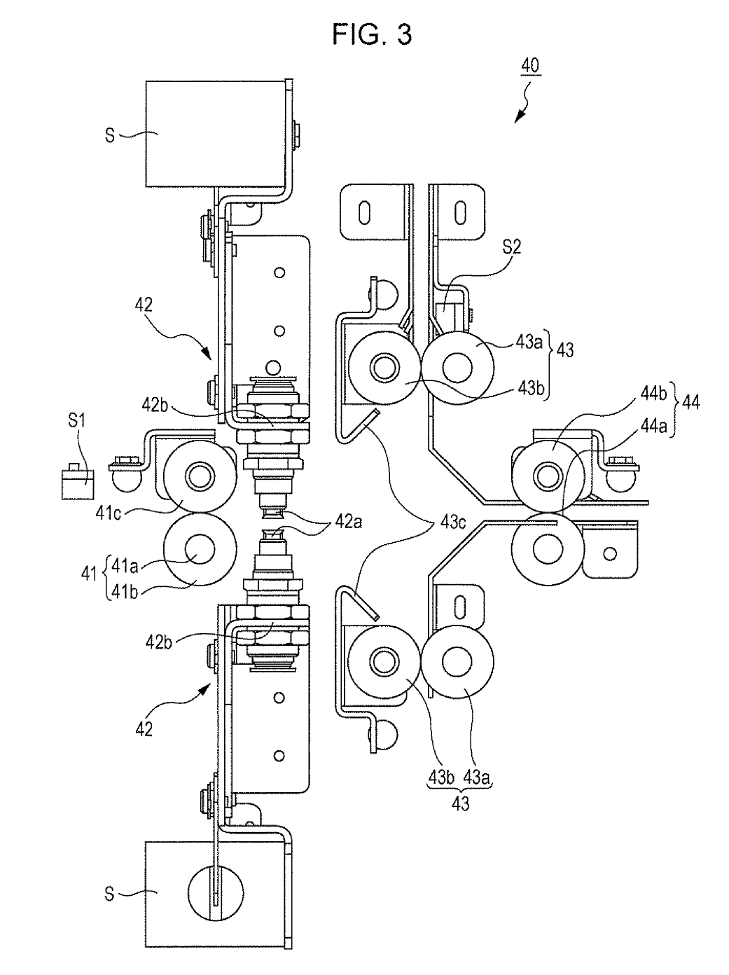

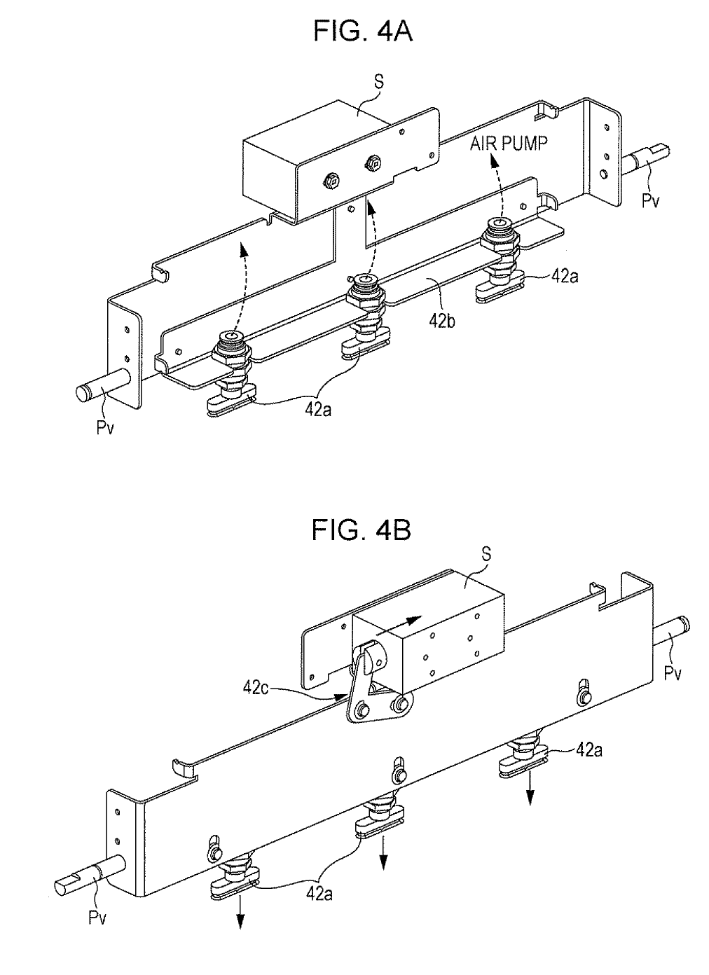

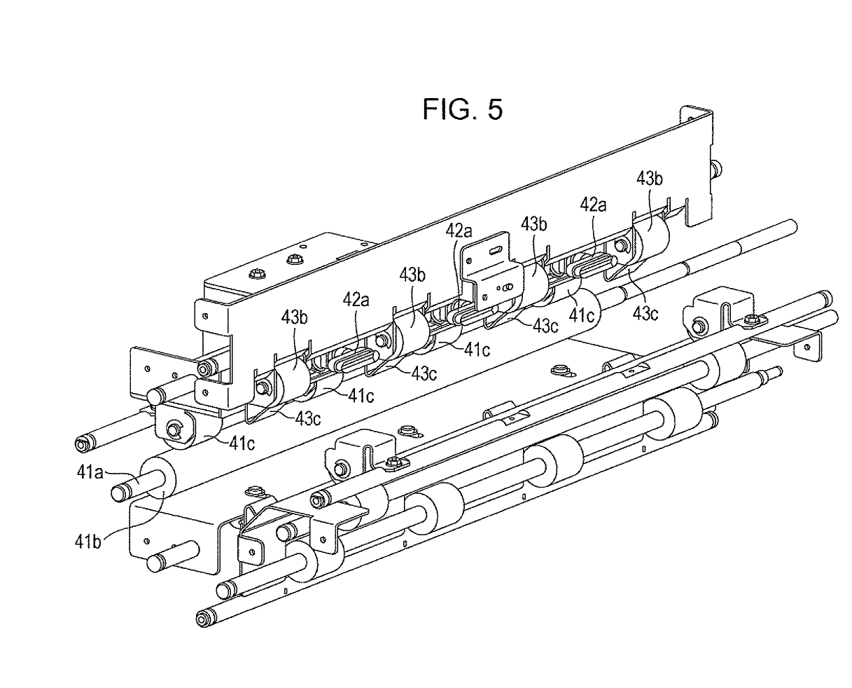

FIG. 3 is a vertical sectional view illustrating a configuration of the film releasing device 40 according to the exemplary embodiment. FIG. 4A is a perspective view of one of a pair of suction cup units 42 seen from a side from which the card substrate 1 is fed thereto. FIG. 4B is a perspective view of the suction cup unit 42 seen from a side from which the card substrate 1 is discharged. FIG. 5 is a perspective view illustrating an internal configuration of one of a pair of film-discharging-roller units 43 seen from the side from which the card substrate 1 is discharged. Referring to these drawings, a configuration of the film releasing device 40 will now be described.

The film releasing device 40 includes the following: a transport roller 41 as a transport member configured to transport the stack that has been cooled to a temperature below the glass transition temperature and has been discharged from the side of the image transferring device 30 on which the tension rollers 32 are provided; the pair of suction cup units 42 as negative-pressure-generating units configured to generate negative pressures on the surfaces of the front-side film 3 and the back-side film 5, respectively, included in the stack that has been transported thereto from the transport roller 41 and to attract the front-side film 3 and the back-side film 5; the pair of film-discharging-roller units 43 configured to discharge, toward the upper side and the lower side, respectively, the front-side film 3 and the back-side film 5 that have been guided thereto while being attracted to and held by the suction cup units 42; and a substrate-discharging-roller unit 44 configured to discharge the card substrate 1 having images transferred from the front-side film 3 and the back-side film 5 that have been released from the card substrate 1.

The transport roller 41 is provided on the downstream side of the tension rollers 32 of the image transferring device 30 in the direction of transport of the stack. The transport roller 41 includes a rotating shaft 41a that is driven to rotate, and a transport roller portion 41b that is supported by the rotating shaft 41a. The transport roller portion 41b is a cylindrical member made of an elastic material such as rubber and may include a rubber portion having a length in the axial direction that is larger than the width of the stack to be transported.

Plural idle rollers 41c are rotatably in contact with the transport roller portion 41b.

The suction cup units 42 each include plural suction cups 42a that are to be brought into contact with a corresponding one of the front-side film 3 and the back-side film 5, a supporting plate 42b supporting the suction cups 42a, and an advancing-and-retracting mechanism 42c configured to advance and retract the supporting plate 42b in the vertical direction.

The suction cups 42a are made of a flexible material such as rubber or resin and are to be brought into contact with the surface of the front-side film 3 or the back-side film 5. The suction cups 42a are connected to an air suction source (such as an air pump, not illustrated).

The supporting plate 42b that supports the suction cups 42a is movably supported by a body of the suction cup unit 42 and is vertically movable back and forth by a solenoid S, which is a drive source provided on the body of the suction cup unit 42, between a contact position where the suction cups 42a are brought into contact with the front-side film 3 or the back-side film 5 and a retracted position where the suction cups 42a are retracted from the front-side film 3 or the back-side film 5.

The body of the suction cup unit 42 has pivot shafts Pv provided on both sides thereof and about which the body pivots. The body is movable (pivotable) by a movement mechanism (not illustrated) between a position where suction is applied to the front-side film 3 or the back-side film 5 that is in contact with the suction cups 42a (hereinafter referred to as “suction position”) and a position where the front-side film 3 or the back-side film 5 to which suction is being applied is delivered to a corresponding one of the film-discharging-roller units 43 (hereinafter referred to as “delivery position”).

The film-discharging-roller units 43 each include plural pairs (four pairs in FIG. 5) of driving rollers 43a and follower rollers 43b that face the respective driving rollers 43a. The pairs of driving rollers 43a and follower rollers 43b are arranged at predetermined intervals in the axial direction.

The follower rollers 43b are paired with respective guides 43c that guide the surface of the front-side film 3 or the back-side film 5 that is to be discharged while being nipped by the film-discharging-roller unit 43. The guides 43c are provided on the upstream side of the film-discharging-roller unit 43. Hence, a space extending over a predetermined length in the axial direction is provided between the suction position and the delivery position. The suction cups 42a to which the front-side film 3 or the back-side film 5 is attracted are allowed to turn in the space.

The substrate-discharging-roller unit 44 includes plural driving rollers 44a and plural follower rollers 44b that face the respective driving rollers 44a. The driving rollers 44a and the follower rollers 44b are arranged at predetermined intervals in the axial direction.

### (2) Operation of Film Releasing Device

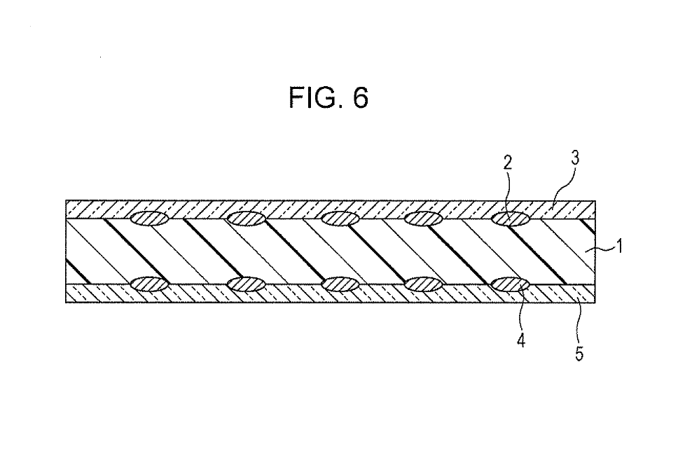

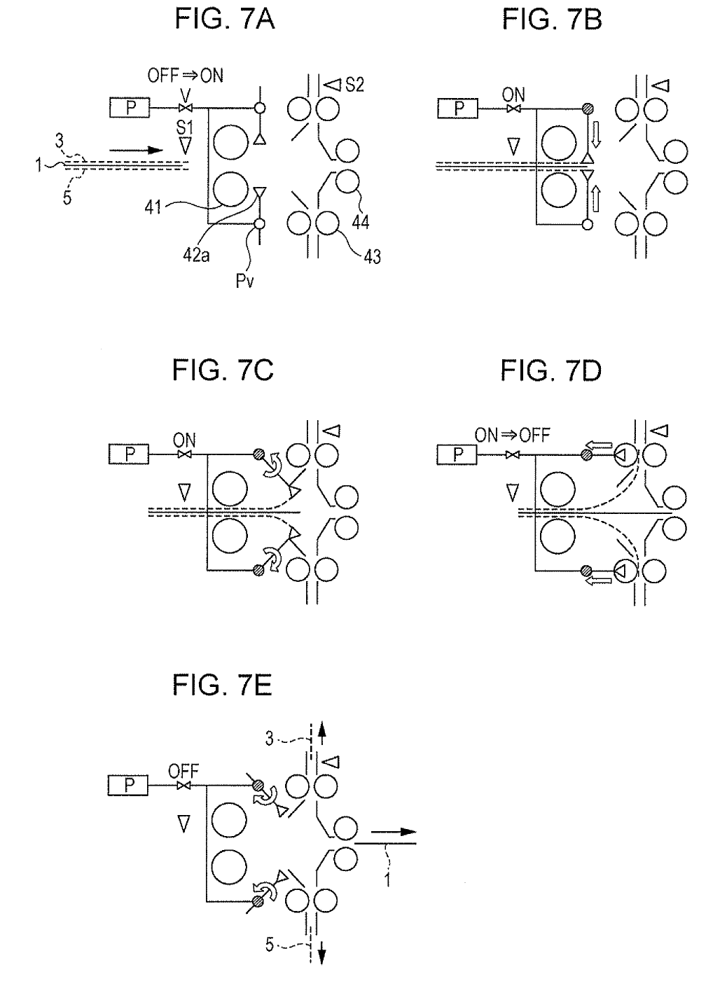

FIG. 6 is a sectional view illustrating a configuration of the stack including the card substrate 1 on which the front-side film 3 and the back-side film 5 having respective images thereon are stacked. FIGS. 7A to 7E are schematic diagrams illustrating steps of a film releasing operation performed by the film releasing device 40.

Referring to the drawings, the film releasing operation performed by the film releasing device 40 according to the exemplary embodiment will now be described, in which the front-side film 3 and the back-side film 5 are released from the stack, and the card substrate 1 having the images transferred thereto is discharged from the film releasing device 40.

### (2.1) Stack

As illustrated in FIG. 6, the stack includes the card substrate 1, the front-side film 3, and the back-side film 5. The front-side film 3 and the back-side film 5, which correspond to transfer films and have respective images 2 and 4, are each laminated to the card substrate 1 such that a side thereof having a corresponding one of the images 2 and 4 faces the card substrate 1.

The card substrate 1 includes an integrated-circuit (IC) chip. The IC chip includes an IC tag that is capable of radio communication. Therefore, the card substrate 1 is capable of transmitting and receiving information via the IC chip in a contactless manner. The IC chip according to the exemplary embodiment stores, in advance, information on the medium, such as the kind of the material of the card substrate 1, the size of the card substrate 1, and so forth.

The card substrate 1 may be opaque or may be colored in white so that the respective images on the transfer films that are stacked thereon are clearly visible.

Accordingly, the card substrate 1 may be made of acetate film, cellulose triacetate film, nylon film, polyester film, polycarbonate film, polystyrene film, polyphenylene sulfide film, polypropylene film, polyimide film, cellophane, or the like. In particular, polyester film is suitable for the card substrate 1. More specifically, biaxially drawn polyethylene-terephthalate (PET) film is suitable for the card substrate 1.

The card substrate 1 is thick enough to have a strength that meets required conditions of the card substrate 1. Preferably, the card substrate 1 is made of PET film having a thickness of 50 to 5000 μm or more preferably 100 to 1000 μm.

The front-side film 3 and the back-side film 5 includes film-type base layers 3a and 5a, respectively. Image receiving layers 3b and 5b are provided on the base layers 3a and 5a, respectively. Preferably, the base layers 3a and 5a are each made of, for example, PET film having a thickness of 50 to 500 μm or more preferably 75 to 150 μm.

The base layers 3a and 5a each need to be transparent, specifically, transparent enough to at least allow a corresponding one of the images 2 and 4 to be visible therethrough from a side opposite the side having the image 2 or 4.

### (2.2) Operation of Releasing Transfer Films

After the stack is heat-sealed with heat and pressure applied thereto by the heating-and-pressing rollers 35, the stack passes through the nip between the cooling rollers 36, thereby being cooled to a temperature below the glass transition temperature. The stack is then transported through the gap between the tension rollers 32 to the transport roller 41 of the film releasing device 40. When the leading end of the stack is detected by a leading-end-detecting sensor S1, a valve V is turned on, whereby a negative pressure is generated in each of the suction cups 42a (see FIG. 7A).

Subsequently, in synchronization with the timing at which the leading end of the stack reaches the downstream side of the transport roller 41, the suction cups 42a supported by the supporting plates 42b that are movably provided on the bodies of the respective suction cup units 42 are brought into contact with the two sides of the stack.

Thus, the suction cups 42a, which are made of a flexible material such as rubber or resin and are connected to an air suction source (air pump P), are in contact with the surfaces of the front-side film 3 and the back-side film 5 (see FIG. 7B).

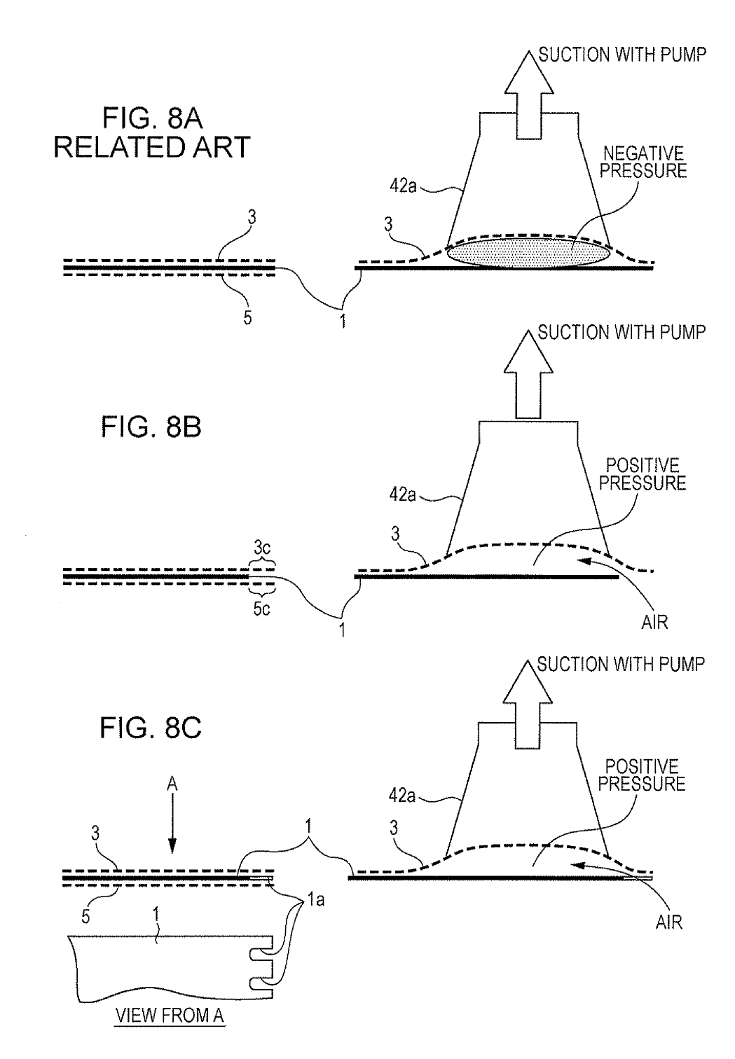

In a related art illustrated in FIG. 8A, when the air pump P applies air suction to the surfaces of the front-side film 3 and the back-side film 5 via the suction cups 42a that are in contact therewith at the contact position, regions of the front-side film 3 and the back-side film 5 that are in contact with the suction cups 42a deform in conformance to the shape of the suction cups 42a with the suction force exerted through the suction cups 42a. As the air suction continues, a negative pressure is generated between the card substrate 1 and each of the front-side film 3 and the back-side film 5, which do not have air permeability, whereby a strong attractive force occurs between the card substrate 1 and each of the front-side film 3 and the back-side film 5. This may prevent the releasing of the front-side film 3 and the back-side film 5 from the card substrate 1 by using the suction cups 42a.

In the film releasing device 40 according to the exemplary embodiment, a portion of each of suction areas defined between the card substrate 1 and the front-side film 3 and the back-side film 5 that are attracted to suction faces of the suction cups 42a communicates with the atmosphere. Hence, the front-side film 3 and the back-side film 5 are attracted to the suction cups 42a while the pressure in the suction areas is maintained to be positive.

Furthermore, while the front-side film 3 and the back-side film 5 are attracted to and held by the suction cups 42a, the suction cup units 42 are rotated about the pivot shafts Pv along respective arc-shaped paths so that the front-side film 3 and the back-side film 5 are guided to the respective film-discharging-roller units 43 (see FIG. 7C).

Subsequently, when the front-side film 3 and the back-side film 5 reach the nips of the respective film-discharging-roller units 43, the valve V is turned off, and the suction cups 42a are then retracted from the paths along which the films 3 and 5 are transported. Since the film-discharging-roller units 43 are each provided at a position that is tangent to a corresponding one of the arc-shaped paths along which the suction cups 42a move, the leading ends of the front-side film 3 and the back-side film 5 are guided to the nips of the respective film-discharging-roller units 43 (see FIG. 7D).

Subsequently, when the trailing ends of the front-side film 3 and the back-side film 5 pass by respective film detecting sensors S2 (see FIG. 7A), the suction cup units 42 return to the initial positions (see FIG. 7E) and become ready for the subsequent film releasing operation.

Specific examples will now be described, in each of which a portion of each of the suction areas defined between the card substrate 1 and the front-side film 3 and the back-side film 5 that are attracted to the suction faces of the suction cups 42a communicates with the atmosphere so that the pressure in the suction areas is maintained to be positive.

### EXAMPLE 1

FIG. 8B is a schematic diagram illustrating an operation of releasing the front-side film 3 and the back-side film 5 from the stack in which, in the direction of transport, the leading end of each of the front-side film 3 and the back-side film 5 projects beyond the leading end of the card substrate 1.

As illustrated in FIG. 8B, the card substrate 1 employed in the film releasing device 40 according to Example 1 has a shorter length than the front-side film 3 and the back-side film 5 in the direction of transport but has substantially the same length as the front-side film 3 and the back-side film 5 in the direction that is orthogonal to and parallel to the direction of transport (i.e., in the width direction).

In releasing the front-side film 3 and the back-side film 5 from the card substrate 1, the suction cups 42a are brought into contact with the front-side film 3 and the back-side film 5 such that a part of the suction face of each suction cup 42a overlaps a corresponding one of projecting portions 3c and 5c of the front-side film 3 and the back-side film 5, whereby a suction area is defined. Hence, a region of each of the front-side film 3 and the back-side film 5 in the suction area deforms in conformance to the shape of the suction cup 42a with the suction force exerted through the suction cup 42a, and a negative pressure is generated in the space defined between the deformed region and the inner surface of the suction cup 42a.

Meanwhile, a portion of the suction area between the leading end of the card substrate 1 and each of the projecting portions 3c and 5c of the front-side film 3 and the back-side film 5 communicates with the atmosphere. Therefore, air flows into the space defined between the card substrate 1 and the attracted region of each of the front-side film 3 and the back-side film 5, and the pressure in the space becomes positive.

Hence, when the supporting plates 42b supporting the suction cups 42a are rotated from the suction position, the front-side film 3 and the back-side film 5 are easily released from the respective sides of the card substrate 1 while the front-side film 3 and the back-side film 5 continue to be attracted to the suction cups 42a. The front-side film 3 and the back-side film 5 thus released from the card substrate 1 are guided to the respective film-discharging-roller units 43 while being attracted to and held by the suction cups 42a, and are discharged to the outside of the film releasing device 40.

### EXAMPLE 2

FIG. 8C is a schematic sectional view illustrating an operation of releasing the front-side film 3 and the back-side film 5 from the stack in which the card substrate 1 has cuts 1a at the leading end thereof in the direction of transport while the front-side film 3 and the back-side film 5 are stacked on the card substrate 1 in such a manner as to cover the cuts 1a.

As illustrated in FIG. 8C, the card substrate 1 employed in the film releasing device 40 according to Example 2 has, at the leading end thereof, the cuts 1a reach a region of the card substrate 1 that faces the suction face of the suction cup 42a. The front-side film 3 and the back-side film 5 extend over the cuts 1a.

The suction cup 42a comes into contact with the front-side film 3 or the back-side film 5 such that the suction face thereof overlaps the cuts 1a of the card substrate 1, whereby a suction area is defined. Hence, a region of each of the front-side film 3 and the back-side film 5 in the suction area deforms in conformance to the shape of the suction cup 42a with the suction force exerted through the suction cup 42a, and a negative pressure is generated in the space defined between the deformed region and the inner surface of the suction cup 42a.

The cuts 1a provided in the card substrate 1 do not necessarily extend through the card substrate 1 and may be grooves provided in the surface of the card substrate 1.

Meanwhile, a portion of the suction area defined between the card substrate 1 and each of the front-side film 3 and the back-side film 5 communicates with the atmosphere via the cuts 1a of the card substrate 1. Therefore, air flows into the space defined between the card substrate 1 and the attracted region of each of the front-side film 3 and the back-side film 5, and the pressure in the space becomes positive.

Hence, when the supporting plates 42b supporting the suction cups 42a are rotated from the suction position, the front-side film 3 and the back-side film 5 are easily released from the respective sides of the card substrate 1 while the front-side film 3 and the back-side film 5 continue to be attracted to the suction cups 42a. The front-side film 3 and the back-side film 5 thus released from the card substrate 1 are guided to the respective film-discharging-roller units 43 while being attracted to and held by the suction cups 42a, and are discharged to the outside of the film releasing device 40.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A film releasing device comprising:
at least one transport member configured to transport a stack of a substrate and a film and to discharge the stack;
a negative-pressure-generating unit provided on a discharge side of the transport member and configured to attract the film with a negative pressure generated on a surface of the film; and
a communicating portion communicating with atmosphere and provided in a region of the film that is on a side facing the substrate, the region overlapping a part of a negative-pressure-generated area of the film,
wherein the film is released from the substrate in such a manner as to be guided in a direction that is different from a direction of discharge while the film is attracted to the negative-pressure-generating unit.

2. The film releasing device according to claim 1,
wherein the negative-pressure-generating unit is connected to an air suction source capable of performing air suction and includes a contact member to be brought into contact with a peripheral portion of the film at a leading end in a direction of transport when air suction is performed by the air suction source, and
wherein the contact member releases the film from the substrate by lifting the film in a direction intersecting the direction of discharge at a position where the contact member is brought into contact with the film.

3. The film releasing device according to claim 1,
wherein the film included in the stack includes a projecting portion where at least a portion of the film projects beyond an end of the substrate, and
wherein the negative-pressure-generating unit is configured to attract a region of the film that includes the projecting portion.

4. The film releasing device according to claim 1,
wherein the substrate included in the stack has a cut at an end thereof, and
wherein the negative-pressure-generating unit is configured to attract a region of the film that includes a portion facing the cut.

5. A film releasing method comprising:
transporting a stack of a substrate and a film and discharging the stack;
attracting the film with a negative pressure generated on a surface of the film; and
allowing atmosphere to communicate with a communicating portion provided in a region of the film that is on a side facing the substrate, the region overlapping a part of a negative-pressure-generated area of the film,
wherein the film is released from the substrate in such a manner as to be guided in a direction that is different from a direction of discharge while the film is attracted to the negative-pressure-generating unit.
